(19) United States
(12) Patent Application Publication
(10) Pub. No.: US 2015/0315453 A1
(43) Pub. Date: Nov. 5, 2015

(54) HIGH TEMPERATURE AND HIGH PRESSURE FLUID LOSS ADDITIVES AND METHODS OF USE THEREOF

(71) Applicant: HERCULES INCORPORATED, Wilmington, DE (US)

(72) Inventors: Marc A. Alexandre, Orange, NJ (US); Gregory Victor Lifton, Wilmington, DE (US); Mohand Melbouci, Wilmington, DE (US); Janice Jianzhao Wang, Hockessin, DE (US)

(21) Appl. No.: 14/704,403

(22) Filed: May 5, 2015

Related U.S. Application Data
(60) Provisional application No. 61/988,698, filed on May 5, 2014.

(51) Int. Cl. C09K 8/12; E21B 7/00; E21B 21/00

(52) U.S. Cl. CPC C09K 8/12; E21B 21/003; E21B 7/00; C09K 2208/12; C09K 2208/32

(57) ABSTRACT

Disclosed are high temperature and high pressure fluid loss additives comprising: a) a humic substance, and b) a tetrapolymer prepared from polymerizing: i) acrylamide (AM), ii) 2-acrylamido-2-methylpropane sulfonic acid (AMPS), iii) 1-allyloxy-2-hydroxypropyl sulfonate, and iv) acrylic acid. The use of such high temperature and high pressure fluid loss additives in water-based drilling fluids in oil-field drilling operations is also disclosed.

### CROSS REFERENCE TO RELATED APPLICATIONS

The present application claims the benefit under 35 U.S.C. 119 (e) of U.S. Provisional Patent Application Ser. No. 61/988,698, filed on May 5, 2014, the entire content of which is hereby expressly incorporated herein by reference.

### BACKGROUND OF THE INVENTION

1. Field of the Disclosed and Claimed Inventive Concepts

The presently disclosed and/or claimed inventive process(es), procedure(s), method(s), product(s), result(s), and/or concept(s) (collectively hereinafter referred to as the “presently disclosed and/or claimed inventive concept(s)”) relates generally to high temperature and high pressure fluid loss additives comprising: a) a humic substance, and b) a tetrapolymer prepared from polymerizing monomers comprising: i) acrylamide (AM), ii) 2-acrylamido-2-methylpropane sulfonic acid (AMPS), iii) 1-allyloxy-2-hydroxypropyl sulfonate (AHPS), and iv)acrylic acid (AA). More particularly, but not by way of limitation, the presently disclosed and/or claimed inventive concept(s) further relates to the use of such high temperature and high pressure fluid loss additives in water-based wellbore service muds in oil-field downhole operations.

2. Background and Applicable Aspects of the Presently Disclosed and Claimed Inventive Concept(s)

Fluid loss additives (FLAs) are widely used in wellbore fluids such as drilling muds and cementing slurries to: minimize the loss of fluid to the formation through filtration, separate fluids to prevent comingling, help operators retain the key characteristics of their drilling fluids including viscosity, thickening time, rheology, comprehensive strength-development, and minimize the high risk of permeability damage.

Natural biopolymers such as cellulosic polymers, starches, modified starches, and carboxymethyl cellulose (CMC)/polysaccharides have been used as FLAs. However the thermal stability of the starch and cellulose derivatives is below 250-300° F., which is not suitable for challenging wellbore drilling operations such as high temperature and high pressure (HTHP). Therefore, synthetic polymers are typically used as FLAs in the severe drilling and cementing conditions. Solution polymerization and other polymerization techniques are typically used to manufacture synthetic fluid loss additives.

As more and more challenging conditions are encountered in oilfield drilling operations, there is a need for improved high-performance fluid loss additives and rheology modifiers, allowing enhanced performance of the drilling fluids and faster and safer drilling.

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed herein can be made and executed without undue experimentation in light of the present disclosure. While the compositions and methods of the presently disclosed and/or claimed inventive concept(s) have been described in terms of preferred embodiments, it will be apparent to those of ordinary skill in the art that variations may be applied to the compositions and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As referred to herein, HTHP refers generally to wells or wellbores that are hotter or at higher pressure, or are both hotter and at higher pressure than most wells or wellbores. In accordance with an embodiment, HTHP can refer to a well or wellbore having an undisturbed bottomhole temperature of greater than about 300° F. [about 149° C.] or greater than about 325° F. [about 163° C.] or greater about 350° F. [about 177° C.]; a pore pressure of at least about 0.8 psi/ft (˜15.3 lbm/gal) or at least about 1.0 psi/ft (˜19.1 lbm/gal) or at least about 1.5 psi/ft (˜28.7 lbm/gal); and a differential pressure of at least about 500 psi or at least about 600 psi or at least about 700 psi.

In accordance with an embodiment of the presently disclosed and/or claimed inventive concept(s), a high temperature and high pressure fluid loss additive comprises, consists of, or consists essentially of:
a) a humic substance selected from the group consisting of a humic acid, a humate, and combinations thereof; and
b) a tetrapolymer prepared from polymerizing monomers comprising:
   i) acrylamide;
   ii) 2-acrylamido-2-methylpropane sulfonic acid;
   iii) 1-allyloxy-2-hydroxypropyl sulfonate; and
   iv) acrylic acid.

In accordance with an embodiment, a humic substance can comprise a humic acid, or a humic substance can comprise a humate, or a humic substance can comprise a humic acid and a humate.

In accordance with an embodiment, at least a portion of the humic substance can be mixed with the tetrapolymer; or at least a portion of the humic substance can be grafted onto the tetrapolymer; or at least a portion of the humic substance can be mixed with the tetrapolymer and at least a portion of the humic substance can be grafted onto the tetrapolymer.

In accordance with an embodiment, the humic substance can be present in an amount of from about 20 to about 80 wt %, or from about 30 to about 70 wt %, or from about 40 to about 60 wt %, based on the total weight of the high temperature and high pressure fluid loss additive.

In accordance with an embodiment, the tetrapolymer can be present in an amount of from about 20 to about 80 wt %, or from about 30 to about 70 wt %, or from about 40 to about 60 wt %, based on the total weight of the high temperature and high pressure fluid loss additive.

In accordance with an embodiment, the tetrapolymer can be prepared from polymerizing monomers comprising:

from about 5 to about 50 wt %, or from about 10 to about 40 wt %, or from about 15 to about 30 wt % of acrylamide;

from about 5 to about 75 wt %, or from about 15 to about 60 wt %, or from about 40 to about 60 wt % of 2-acrylamido-2-methylpropane sulfonic acid;

from about 5 to about 50 wt %, or from about 10 to about 40 wt %, or from about 15 to about 30 wt % of 1-allyloxy-2-hydroxypropyl sulfonate; and

from about 5 to about 30 wt %, or from about 6 to about 20 wt %, or from about 7 to about 10 wt % of acrylic acid.

In accordance with an embodiment, the humate described herein can be selected from the group consisting of potassium humate, sodium humate, and combinations thereof. In addition, the humate can be potassium humate or the humate can be sodium humate or the humate can comprise both potassium humate and sodium humate.

In accordance with another embodiment, the high temperature and high pressure fluid loss additive can further be combined with at least one rheology modifier. Such rheology modifier can be selected from the group consisting of poly (vinylpyrrolidone/acrylic acid), poly(acrylamide/2-acrylamido-2-methylpropane sulfonic acid), xanthan gum, hydroxyethylcellulose, carboxymethyl cellulose, poly(anionic cellulose), bentonite, and combinations thereof.

In accordance with an embodiment, a water-based drilling fluid can comprise, consist of, or consist essentially of:

water; and

any of the high temperature and high pressure fluid loss additive(s) as described herein.

The water-based drilling fluid can employ either (i) fresh water or (ii) a suitable brine solution as a base fluid during drilling operations. The water-based drilling fluid may also comprise seawater or a solution of a salt or a solution of a combination of salts required thereof.

Generally, the brine solution is present in an amount to achieve the density of from about 8.3 to 21.0 ppg. The brine solution may be an aqueous solution of one or more density increasing water-soluble salts. The density increasing water-soluble salt may be selected from the group consisting of alkali metal halides (for example, sodium chloride, sodium bromide, potassium chloride, potassium bromide, magnesium chloride, ammonium chloride), alkali metal carboxylates (for example, sodium formate, potassium formate, caesium formate, sodium acetate, potassium acetate or caesium acetate), alkali metal carbonates (for example, sodium carbonate or potassium carbonate, alkaline earth metal halides (for example, calcium chloride or calcium bromide), and zinc halide salts (for example, zinc chloride or zinc bromide) and mixtures thereof. In accordance with an embodiment, the salt for preparing the brine solution herein can be selected from the group consisting of sodium chloride, potassium chloride, calcium chloride, magnesium chloride, ammonium chloride, zinc chloride, sodium bromide, calcium bromide, zinc bromide, potassium formate, cesium formate, sodium formate and mixtures thereof.

In accordance with an embodiment, the humic substance can be present in an amount of from about 1 to about 20, or from about 3 to about 10, or from about 6 to about 8 pounds per barrel of the water-based drilling fluid. Also, the tetrapolymer can be present in an amount of from about 1 to about 20, or from about 3 to about 10, or from about 4 to about 6 pounds per barrel of the water-based drilling fluid.

In accordance with an embodiment, the water-based drilling fluid can further comprise at least one component selected from the group consisting of: rheology modifiers (as described above), dispersants, shale stabilizers or inhibitors, clay swell inhibitors, pH controlling agents or buffers, antifoamers, wetting agents, corrosion inhibitors, lubricants, biocides, other fluid loss additives, and combinations thereof; or the water-based drilling fluid can further comprise at least one component selected from the group consisting of: rheology modifiers (as described above), dispersants, shale stabilizers or inhibitors, clay swell inhibitors, pH controlling agents or buffers, antifoamers, wetting agents, corrosion inhibitors, lubricants, biocides, or other fluid loss additives. Also, the water-based drilling fluid can have a pH from about 6 to about 13, or from about 8 to about 11, or from about 9 to about 10.

In accordance with an embodiment, the water-based drilling fluid as described herein has a fluid loss, as measured at a differential pressure of 500 psi and 350° F. using the API RP 13B-1 test method, which is not exceeding 25 ml/30 minutes.

In accordance with another embodiment, a method for performing a drilling operation in a high temperature and high pressure wellbore, as described herein, comprises, consists of, or consists essentially of utilizing the water-based drilling fluid as described herein in a high temperature and high pressure wellbore in the performance of a drilling operation.

The following examples illustrate the presently disclosed and claimed inventive concept(s), parts and percentages being by weight, unless otherwise indicated. Each example is provided by way of explanation of the presently disclosed and claimed inventive concept(s), not limitation of the presently disclosed and claimed inventive concept(s). In fact, it will be apparent to those skilled in the art that various modifications and variations can be made in the presently disclosed and claimed inventive concept(s) without departing from the scope or spirit of the invention. For instance, features illustrated or described as part of one embodiment, can be used on another embodiment to yield a still further embodiment. Thus, it is intended that the presently disclosed and claimed inventive concept(s) covers such modifications and variations as come within the scope of the appended claims and their equivalents.

### EXAMPLES

### Example 1

### Polymer formulations

### Polymer A: Tetrapolymer of AA/AMPS/AHPS/ACM

To a 1 L reactor, equipped with water condenser, stirrer, temperature controller, N₂ inlet/outlet, and oil batch, was added 117.5 g of AHPS (40 wt % aqueous solution), 185.6 g of deionized water and 1.6 g of Versene™ 100 chelating agent (obtained from the DOW Chemical Company) to form a mixture. After the mixture became a homogenous solution, the reactor was purged with N₂ and the temperature was raised to 65° C. Meanwhile, a monomer solution was prepared, containing 211.3 g of AMPS monomer (AMPS® 2403, 50 wt % aqueous solution, obtained from the Lubrizol Corporation), 0.375 g of N,N′ methylenebisacrylamide, 44.2 g of acrylamide crystal (98 wt % active acrylamide), and 44.2 g of deionized water. After a 30 min purge, the monomer solution and 1.37 g of sodium persulfate dissolved in 51 g of deionized water (1^{st} initiator solution) were added into the reactor in separate pumps over 200 min. After such charging, 4.277 g of sodium persulfate dissolved in 44 g of deionized water (2^{nd} initiator solution) was added into the reactor over 90 min. After 30 min of such feeding of 2^{nd} initiator solution, 16 g of acrylic acid was added into the reactor, simultaneously with the remaining 2^{nd} initiator solution over 1 hr. After the feeding, the reactor temperature was raised to and maintained at 80° C. for an additional 2 hrs. The reactor was then cooled down and the formed Polymer A material was discharged. The Polymer A was further dried and ground into powders by removing water in a rotavapor and a vacuum oven at 100° C. for 2 hr.

Polymer B: Tetrapolymer of AA/AMPS/AHPS/ACM Grafted with Humate

To a 1 L reactor, equipped with water condenser, stirrer, temperature controller, N₂ inlet/outlet, and oil batch, was added 59 g of AHPS (40 wt % aqueous solution), 500 g of deionized water, 1.6 g of Versene™ 100 chelating agent, and 142 g of sodium humate to form a mixture. After the mixture became a homogenous solution, the reactor was purged with N₂ and the temperature was raised to 65° C. Meanwhile, a monomer solution was prepared, containing 105 g of AMPS monomer, 0.18 g of N,N′ methylenebisacrylamide, 22 g of acrylamide crystal, and 22 g of deionized water. After a 30 min purge, the monomer solution and 4.27 g of sodium persulfate dissolved in 44 g of deionized water were added into the reactor in separate pumps over 200 min. After such charging, 8 g of acrylic acid mixed with 120 g of deionized water was added into the reactor over 1 hr. The reactor temperature was raised to and kept at 80° C. for an additional 2 hrs. The reactor was then cooled down and the formed Polymer B material was discharged.

Polymer C: Tetrapolymer of AA/AMPS/DADMAC/ACM Grafted with Humate (Control)

To a 1 L reactor, equipped with water condenser, stirrer, temperature controller, N₂ inlet/outlet and oil batch, was added 23 g of diallyldimethylammonium chloride (DADMAC, 60 wt % aqueous solutions), 52.8 g of AMPS monomer, 11.1 g of acrylamide crystal and 600 g of deionized water. 50 g of sodium humate was then added into the reactor to form a mixture. After the mixture became a homogenous solution, the reactor was purged with N₂ and the temperature was raised to 75° C. After a 30 min purge, 4.27 g of sodium persulfate dissolved in 44 g of deionized water was added as an initiator over 200 min. After the initiator charging, 4 g of acrylic acid was added into the reactor. The reactor temperature was kept at 75° C. for an additional 2 hrs. The reactor was then cooled down and the formed Polymer C material was discharged.

Polymer D: Terpolymer of AA/AMPS/ACM Grafted with Humate (Control)

To a 1 L reactor, equipped with water condenser, stirrer, temperature controller, N₂ inlet/outlet, and oil batch, was added with 52.8 g of AMPS monomer, 11.1 g of acrylamide crystal and 400 g of deionized water. 40 g of sodium humate was then added into the reactor to form a mixture. After the mixture became a homogenous solution, the reactor was purged with N₂ and the temperature was raised to 75° C. After a 30 min purge, 4.27 g of sodium persulfate dissolved in 44 g of deionized water was added as an initiator over 200 min. After the initiator charging, 4 g of acrylic acid was added into the reactor. The reactor temperature was kept at 75° C. for an additional 2 hrs. The reactor was then cooled down and the formed Polymer D material was discharged.

### Example 2

### Preparation and Testing of Water-Based Wellbore Service Mud

Water-based wellbore service mud formulations were prepared as shown in the following Tables 1-3. The formulations were sufficiently mixed in order to dissolve the polymers and avoid local viscosified agglomerates (fish eyes). The formulations were allowed to agitate for 5-15 minutes between the addition of each component and with 30-50 minutes total for complete and homogenous mixing. Rheological properties were then measured on a FANN model 35 viscometer before and after hot rolling (BHR and AHR) aging tests. For the aging tests, portions of the water-based wellbore service mud formulations were sealed in 500 ml OFITE 316 grade stainless cells under N₂ pressure of 350 psi and aged in an OFITE rolling oven at 400° F. (232° C.) for 16 hours (OFI Testing Equipment Inc., Houston, Tex.). HTHP fluid loss tests on drilling fluid formulations were conducted in accordance with the procedures detailed in API RP 13B-1. The BHR and AHR rheology results and HTHP fluid loss control properties are provided in Tables 1-3 below.

TABLE 1

| | Mixing | Mud Formulation Number | | | | | | | | |
|---|---|---|---|---|---|---|---|---|---|---|
| | Time | I (Control) | | | II (Control) | | | III | | |
| Deionized Water, mL | — | 277 | | | 277 | | | 277 | | |
| Polymer A, ppb⁽¹⁾ | 10 min | — | | | 6.0 | | | 2.0 | | |
| NaOH, 50%, ppb | 30 sec | 3.0 | | | 3.0 | | | 3.0 | | |
| Poly(VP/AA^{)(2),} ppb | 10 min | 2.2 | | | 2.0 | | | 2.0 | | |
| Humic Acid, ppb | 5 min | 10 | | | — | | | 2.2 | | |
| Sodium Humate, 50- | 5 min | — | | | — | | | 5.0 | | |
| 60% active, ppb | | | | | | | | | | |
| API Barite Weighting | 10 min | 311 | | | 311 | | | 311 | | |
| Agent, ppb | | | | | | | | | | |
| Aging Condition | | 400° F./16 hr Static | | | 400° F./16 hr Static | | | 400° F./16 hr Static | | |
| Mud Weight, ppg⁽³⁾ | | 14 | | | 14 | | | 14 | | |
| Fann Data @ 120° F. | | BHR | AHR | R(%)⁽⁴⁾ | BHR | AHR | R(%) | BHR | AHR | R(%) |
| 600 rpm | | 43 | 86 | 200 | 85 | 113 | 133 | 80 | 106 | 133 |
| 300 rpm | | 25 | 57 | 228 | 53 | 80 | 151 | 52 | 76 | 146 |
| 200 rpm | | 19 | 45 | 237 | 40 | 66 | 165 | 39 | 63 | 162 |
| 100 rpm | | 13 | 30 | 231 | 28 | 49 | 175 | 27 | 46 | 170 |
| 6 rpm | | 4 | 8 | 200 | 10 | 16 | 160 | 12 | 14 | 117 |
| 3 rpm | | 3.5 | 6 | 171 | 9 | 13 | 144 | 11 | 12 | 109 |
| 10 Sec gel, lb/100 ft² | | 3.5 | 6.5 | 186 | 9 | 13 | 144 | 11 | 11 | 100 |
| PV⁽⁵⁾, cps | | 18 | 29 | 161 | 32 | 33 | 103 | 28 | 30 | 107 |
| YP⁽⁶⁾, lb/100 ft² | | 7 | 28 | 400 | 21 | 48 | 229 | 24 | 46 | 192 |
| pH value | | 9.9 | 9.6 | | N/A | N/A | | 9.8 | 9.6 | |
| HTHP FL⁽⁷⁾, mL/30 | | — | 19.2 | | — | 37-60⁽⁸⁾ | | — | 18 | |
| min. 500 psi/350° F. | | | | | | | | | | |

⁽¹⁾Pounds per barrel
⁽²⁾Copolymer of vinylpyrrolidone and acrylic acid
⁽³⁾Pounds per gallon
⁽⁴⁾Retention %
⁽⁵⁾Plastic viscosity
⁽⁶⁾Yield point
⁽⁷⁾High temperature, high pressure fluid loss control
⁽⁸⁾Range over several tests

Formulation III was prepared by blending Polymer A, humic acid and sodium humate along with other ingredients listed in Table 1. As can be seen in Table 1, the control Formulation I containing humic acid without Polymer A resulted in Retention %'s for rheology, plastic viscosity and yield point well in excess of the ideal 100% retention, but had an acceptable HTHP fluid loss control. The control Formulation II containing Polymer A without humic acid had an unacceptably elevated HTHP fluid loss control value. The HTHP fluid loss control value for the inventive Formulation III is lower than the HTHP fluid loss control values for the control Formulations II while having 100% or above retention.

TABLE 2

| | Mixing | Mud Formulation Number | | | | | | | | |
|---|---|---|---|---|---|---|---|---|---|---|
| | Time | IV | | | V | | | VI | | |
| Deionized Water, mL | — | 277 | | | 277 | | | 277 | | |
| Polymer A, ppb | 10 min | 4.0 | | | 5.0 | | | 6.0 | | |
| NaOH, 50%, ppb | 30 sec | 3.0 | | | 3.0 | | | 3.0 | | |
| Xanthan Gum, ppb | 10 min | 0.1 | | | 0.1 | | | 0.1 | | |
| Poly(VP/AA), ppb | 10 min | 1.9 | | | 1.9 | | | 1.9 | | |
| Sodium Humate, ppb | 5 min | 6.0 | | | 6.0 | | | 6.0 | | |
| API Barite Weighting | 10 min | 311 | | | 311 | | | 311 | | |
| Agent, ppb | | | | | | | | | | |
| Aging Condition | | 400° F./16 hr Static | | | 400° F./16 hr Static | | | 400° F./16 hr Static | | |
| Mud Weight, ppg | | 14 | | | 14 | | | 14 | | |
| Fann data @ 120° F. | | BHR | AHR | R(%) | BHR | AHR | R(%) | BHR | AHR | R(%) |
| 600 rpm | | 110 | 97 | 88 | 110 | 103 | 94 | 111 | 94 | 85 |
| 300 rpm | | 70 | 63 | 90 | 72 | 70 | 97 | 74 | 63 | 85 |
| 200 rpm | | 53 | 49 | 92 | 53 | 54 | 102 | 57 | 49 | 86 |
| 100 rpm | | 35 | 33 | 94 | 33 | 37 | 112 | 37 | 33 | 89 |
| 6 rpm | | 11 | 9 | 82 | 11 | 10 | 91 | 11 | 8 | 73 |
| 3 rpm | | 9 | 7 | 78 | 9 | 8 | 89 | 9 | 6 | 67 |
| 10 Sec gel, lb/100 ft² | | 11 | 8 | 73 | 11 | 8 | 73 | 10 | 7 | 70 |
| PV, cps | | 40 | 34 | 85 | 38 | 33 | 87 | 37 | 31 | 84 |
| YP, lb/100 ft² | | 30 | 29 | 97 | 34 | 37 | 109 | 37 | 32 | 86 |
| HTHP FL, mL/30 min. | | | 20 | | | 17.4 | | | 21.5 | |
| 500 psi/350° F. | | | | | | | | | | |

As can be seen in Table 2, the inventive Formulations IV, V and VI including Polymer A were physically blended with sodium humate generated consistent rheology before and after aging, as well as excellent HTHP fluid loss of ˜17 to ˜22 ml/30 min. at 350° F./500 psi.

TABLE 3

| | Mixing | Mud Formulation Number | | | | | | | | |
|---|---|---|---|---|---|---|---|---|---|---|
| | Time | VII (Control) | | | VIII (Control) | | | IX | | |
| Fresh Water, mL | — | 190 | | | 214 | | | 280 | | |
| NaOH, 50%, ppb | 30 sec | 3 | | | 3 | | | 3 | | |
| Poly(AA/VP), ppb | 10 min | 1.9 | | | 1.9 | | | 1.9 | | |
| Xanthan Gum, ppb | 10 min | — | | | — | | | 0.1 | | |
| Polymer C (in a 12 | 10 min | 100 | | | — | | | — | | |
| wt % aqueous sol'n), | | | | | | | | | | |
| ppb | | | | | | | | | | |
| Polymer D (in a 16 | 10 min | — | | | 75 | | | — | | |
| wt % aqueous sol'n), | | | | | | | | | | |
| ppb | | | | | | | | | | |
| Polymer B (in a 25 | 10 min | — | | | — | | | 48 | | |
| wt % aqueous sol'n), | | | | | | | | | | |
| ppb | | | | | | | | | | |
| Buffer, ppb | 5 min | 7.6 | | | 7.6 | | | 7.6 | | |
| API Barite Weighting | 10 min | 311 | | | 311 | | | 311 | | |
| Agent, ppb | | | | | | | | | | |
| Aging Condition | | 400° F./16 hr Static | | | 400° F./16 hr Static | | | 400° F./16 hr Static | | |
| Mud Weight, ppg | | 14 | | | 14 | | | 14 | | |
| Fann Data @ 120° F. | | BHR | AHR | R(%)³ | BHR | AHR | R(%) | BHR | AHR | R(%) |
| 600 rpm | | 63 | 87 | 138 | 83 | 81 | 98 | 98 | 91 | 93 |
| 300 rpm | | 37 | 55 | 149 | 55 | 53 | 96 | 61 | 58 | 95 |
| 200 rpm | | 25 | 45 | 180 | 44 | 44 | 100 | 44 | 46 | 105 |
| 100 rpm | | 15 | 31 | 207 | 32 | 31 | 97 | 28 | 31 | 111 |
| 6 rpm | | 5 | 8 | 160 | 15 | 9 | 60 | 9.5 | 9.5 | 100 |
| 3 rpm | | 4 | 6.5 | 163 | 13 | 7 | 54 | 8 | 8.5 | 106 |
| 10 Sec gel, lb/100 ft² | | 6 | 9 | 150 | 15 | 7 | 47 | 8 | 9 | 113 |
| PV, cps | | 26 | 32 | 123 | 28 | 28 | 100 | 37 | 33 | 89 |
| YP, lb/100 ft² | | 11 | 23 | 209 | 27 | 25 | 93 | 24 | 25 | 104 |
| pH value | | | | | | | | | | |
| HTHP FL, mL/30 min. | | — | 22 | — | — | 20 | — | — | 21 | — |
| 500 psi/350° F. | | | | | | | | | | |

As can be seen in Table 3, inventive Formulation IX including tetrapolymer of AA/AMPS/AHPS/ACM grafted with sodium humate generated consistent rheology before and after aging even at lower rpm, as well as good fluid loss, while control Formulation VII including Control Polymer C (tetrapolymer of AA/AMPS/DADMAC/ACM grafted with sodium humate), and control Formulation VIII including Control Polymer D (terpolymer of (AA/AMPS/ACM grafted with sodium humate) gave rheology values with variance before and after aging, especially at lower rpm. Based on the data, AHPS is shown to play an important role to stabilize the mud rheology before and after aging, while maintaining excellent fluid loss control at 350° F./500 psi.

In accordance with an embodiment, when the water-based wellbore service mud as described herein contains xanthan gum (as demonstrated in Formulations IV, V, VI and IX in the above examples), the yield point as measured using a viscometer at 120° F. for the water-based wellbore service mud after aging at 350 psi in a rolling oven at 400° F. for 16 hours is no more than about 10 units different from the yield point as measured using a viscometer at 120° F. for the water-based wellbore service mud before aging.

In accordance with an embodiment, when the water-based wellbore service mud as described herein contains xanthan gum (as demonstrated in Formulations IV, V, VI and IX in the above examples), the rheology as measured at 6 rpm using a viscometer at 120° F. for the water-based wellbore service mud after aging is no more than 3 units different from the rheology as measured at 6 rpm using a viscometer at 120° F. for the water-based wellbore service mud before aging.

In accordance with an embodiment, when the water-based wellbore service mud as described herein contains xanthan gum (as demonstrated in Formulations IV, V, VI and IX in the above examples), the rheology as measured at 3 rpm using a viscometer at 120° F. for the water-based wellbore service mud after aging is no more than 3 units different from the rheology as measured at 3 rpm using a viscometer at 120° F. for the water-based wellbore service mud before aging.

In accordance with an embodiment, when the water-based wellbore service mud as described herein contains xanthan gum (as demonstrated in Formulations IV, V, VI and IX in the above examples), the plastic viscosity as measured using a viscometer at 120° F. for the water-based wellbore service mud after aging is no more than 10 units different from the plastic viscosity as measured using a viscometer at 120° F. for the water-based wellbore service mud before aging.

It is further appreciated that features of the invention which are, for clarity, described in the context of separate embodiments, can also be provided in combination in a single embodiment. Conversely, various features of the invention which are, for brevity, described in the context of a single embodiment, can also be provided separately or in any suitable sub-combination.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Changes may be made in the construction and the operation of the various components, elements and assemblies described herein, and changes may be made in the steps or sequence of steps of the methods described herein without departing from the spirit and the scope of the invention as defined in the following claims.

What is claimed is:

1. A high temperature and high pressure fluid loss additive comprising:
a) a humic substance selected from the group consisting of humic acid, a humate, and combinations thereof; and
b) a tetrapolymer prepared from polymerizing monomers comprising:
i) acrylamide;
ii) 2-acrylamido-2-methylpropane sulfonic acid;
iii) 1-allyloxy-2-hydroxypropyl sulfonate; and
iv) acrylic acid.

2. The high temperature and high pressure fluid loss additive of claim 1, wherein at least a portion of the humic substance is mixed with the tetrapolymer.

3. The high temperature and high pressure fluid loss additive of claim 1, wherein at least a portion of the humic substance is grafted onto the tetrapolymer.

4. The high temperature and high pressure fluid loss additive of claim, 1 wherein the humic substance is present in an amount of from about 20 to about 80 wt % based on the total weight of the high temperature and high pressure fluid loss additive.

5. The high temperature and high pressure fluid loss additive of claim 1, wherein the tetrapolymer is present in an amount of from about 20 to about 80 wt % based on the total weight of the high temperature and high pressure fluid loss additive.

6. The high temperature and high pressure fluid loss additive of claim 1, wherein the tetrapolymer is prepared from polymerizing:
from about 5 to about 50 wt % acrylamide,
from about 5 to about 75 wt % 2-acrylamido-2-methylpropane sulfonic acid,
from about 5 to about 50 wt % 1-allyloxy-2-hydroxypropyl sulfonate, and from about 5 to about 30 wt % acrylic acid.

7. The high temperature and high pressure fluid loss additive of claim 1, wherein the humate is selected from the group consisting of potassium humate, sodium humate, and combinations thereof.

8. A water-based drilling fluid comprising:
water: and
a high temperature and high pressure fluid loss additive comprising:
a) a humic substance selected from the group consisting of humic acid, a humate, and combinations thereof, and
b) a tetrapolymer prepared from polymerizing monomers comprising:
i) acrylamide;
ii) 2-acrylamido-2-methylpropane sulfonic acid;
iii) 1-allyloxy-2-hydroxypropyl sulfonate; and
iv) acrylic acid.

9. The water-based drilling fluid of claim 8, wherein at least a portion of the humic substance is mixed with the tetrapolymer.

10. The water-based drilling fluid of claim 8, wherein at least a portion of the humic substance is grafted onto the tetrapolymer.

11. The water-based drilling fluid of claim 8, wherein the humic substance is present in an amount of from about 1 to about 20 pounds per barrel of the water-based wellbore service mud.

12. The water-based drilling fluid of claim 8, wherein the tetrapolymer is present in an amount of from about 1 to about 20 pounds per barrel of the water-based wellbore service mud.

13. The water-based drilling fluid of claim 8, further comprising at least one component selected from the group consisting of rheology modifiers, dispersants, shale stabilizers or inhibitors, clay swell inhibitors, pH controlling agents or buffers, emulsifiers, antifoamers, wetting agents, surfactants, corrosion inhibitors, lubricants, biocides, shale swell inhibitors, scale inhibitors, corrosion inhibitors, and combinations thereof.

14. The water-based wellbore service mud of claim 8, having a pH from about 6 to about 13.

15. A method for performing drilling operations in a high temperature and high pressure wellbore comprising:
utilizing a water-based drilling fluid in a high temperature and high pressure wellbore in the performance of a drilling operation; wherein the water-based drilling fluid comprises:
water; and
a high temperature and high pressure fluid loss additive comprising:
a) a humic substance selected from the group consisting of humic acid, a humate, and combinations thereof, and
b) a tetrapolymer prepared from polymerizing monomers comprising:
i) acrylamide;
ii) 2-acrylamido-2-methylpropane sulfonic acid;
iii) 1-allyloxy-2-hydroxypropyl sulfonate; and
iv) acrylic acid.

16. The method of claim 15, wherein the high temperature and high pressure wellbore is operated at a temperature of at least about 300° F. and a pressure of at least about 500 psi.

17. The method of claim 15, wherein at least a portion of the humic substance is mixed with the tetrapolymer.

18. The method of claim 15, wherein at least a portion of the humic substance is grafted onto the tetrapolymer.

19. The method of claim 15, wherein the humic substance is present in an amount of from about 1 to about 20 pounds per barrel of the water-based drilling fluid.

20. The method of claim 15, wherein the tetrapolymer is present in an amount of from about 1 to about 20 pounds per barrel of the water-based drilling fluid.
